(19) United States
(12) Patent Application Publication
(10) Pub. No.: US 2004/0155108 A1
(43) Pub. Date: Aug. 12, 2004

(54) Method of establishing a voting system and voting system established by the method

(75) Inventor: Tsuguharu Saito, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/750,899

(22) Filed: Jan. 5, 2004

(30) Foreign Application Priority Data
Feb. 6, 2003 (JP) 2003-029393

(51) Int. Cl. G06F 17/60

(52) U.S. Cl. 235/386

(57) ABSTRACT

A voting system generating method automatically allocates a vote-recording function to a machine that includes a storage medium and that is first connected to a network. The method then automatically allocates a backup vote-recording function to a machine that includes a storage medium and that is secondly or later connected to the network. The method the automatically allocates a normal voting machine function to a machine which includes no storage medium and which is connected to the network after the vote-recording machine is set up.

### BACKGROUND OF THE INVENTION

1. Field of the Invention

The present invention relates to the storage and backup of data via a network, and more particularly relates to the storage and backup of data in an electronic voting system.

2. Description of Related Art

In conventional electronic voting systems, to store voting data, a voting machine has been required to individually hold a storage medium(a stand-alone system) or a machine dedicated to writing has been required (a client-server system). However, in the stand-alone system, since a storage medium is required to be present in each voting machine, the management cost for the storage medium increases in proportion to the number of voting machines. In the client-server system, the server itself is expensive and complicated settings are required for each operation.

A related technique is described in Japanese Patent Laid-Open No. 2002-215474. This document discloses a data backup system via a network for preventing the loss of data by an unexpected failure of a recording device. In the backup system, it is determined that backup data is sent from the nearest server to a substitutive server for backup; however, a method of determining the substitutive server and the nearest server is not described in detail.

### SUMMARY OF THE INVENTION

It is an object of the present invention is to provide a method of establishing a voting system and a voting system established by the method in which a storage medium is not required to be present in every voting machine.

Another object of the present invention is to provide a method of establishing a voting system and a voting system in which the making of settings on the voting machines is facilitated.

A further object of the present invention is to provide a method of establishing a voting system and a voting system in which backup is made in the event of an unexpected failure.

Embodiments within the scope of the present invention may achieve one or more of the above objectives, in whole or in part.

According to one aspect of the present invention, a method of establishing a voting system comprises: automatically allocating the function of a vote-recording machine to a machine which includes a storage medium and which is first connected to a network; automatically allocating the function of a backup voting machine to a machine which includes a storage medium and which is secondly or later connected to the network; and automatically allocating the function of a normal voting machine to a machine which includes no storage medium and which is connected to the network after the vote-recording machine is set up.

According to another aspect of the present invention, a voting system comprises: a normal voting machine that accepts a vote, originates encrypted voting data and outputs the encrypted voting data to a network; a vote-recording machine that receives the encrypted voting data from the normal voting machine via the network, writes the encrypted voting data into a storage medium in the vote-recording machine and outputs the encrypted voting data to the network; and a backup voting machine which receives the encrypted voting data from the vote-recording machine via the network, writes the encrypted voting data into a storage medium in the backup voting machine and outputs information that backup is completed in the backup voting machine to the network.

Other and further objects of the present invention will be more apparent upon an understanding of the illustrative embodiments about to be described or will be indicated in the appended claims, and various advantages not referred to herein will occur to one skilled in the art upon use of the invention in practice.

### BRIEF DESCRIPTION OF THE DRAWINGS

For a better understanding of the invention as well as other objects and features thereof, reference is made to the following detailed description to be read in conjunction with the accompanying drawings, wherein:

FIG. 1 is a block diagram showing a structure of a voting system according to an embodiment of the present invention;

FIG. 2 is a flowchart showing an operation when a vote-recording machine is connected to a network;

FIG. 3 is a flowchart showing an operation when a backup voting machine is connected to the network;

FIG. 4 is a flowchart showing an operation when a normal voting machine is connected to the network;

FIG. 5 is a block diagram showing a structure in a state in which processing shown in FIGS. 2 to 4 is executed;

FIG. 6 is a flowchart showing an operation when the encrypted voting data is recorded; and

FIG. 7 is a flowchart showing an operation when a spare voting machine is set in case a fault occurs in the vote-recording machine.

### DETAILED DESCRIPTION OF PREFERRED EMBODIMENTS

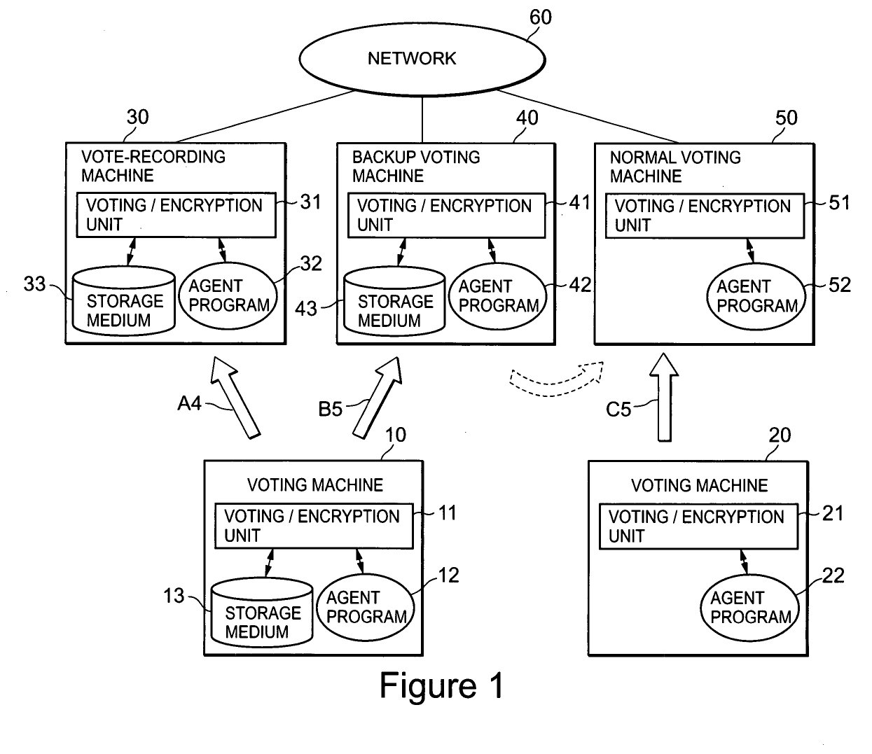

Referring to FIG. 1, a voting machine 10 includes a voting/encryption unit 11, an agent program 12 and a storage medium 13. The voting/encryption unit 11 displays the full names and the assignments of candidates and encrypts a selected candidate and the identification of the selected candidate. The agent program 12 designates the role of the voting machine 10 and controls the voting machine 10. The storage medium 13 records voting data. A voting machine 20 includes a voting/encryption unit 21 and an agent program 22, but no storage medium. The voting machines 10 and 20 are transformed into a vote-recording machine 30, a backup voting machine 40 and a normal voting machine 50 according to their roles which are designated by the agent programs 12 and 22 in the voting machines 10 and 20. The voting machine 10 including the storage medium 13 functions as the vote-recording machine 30 or the backup voting machine 40, whereas the voting machine 20 including no storage medium functions as the normal voting machine 50.

The function of the vote-recording machine 30 is to record voting data. The vote-recording machine 30 includes a voting/encryption unit 31, an agent program 32 and a storage medium 33, which correspond to the voting/encryption unit 11, the agent program 12 and the storage medium 13, respectively. The function of the backup voting machine 40 is to back up data recorded by the vote-recording machine 30. The backup voting machine 40 includes a voting/encryption unit 41, an agent program 42 and a storage medium 43, which correspond to the voting/encryption unit 11, the agent program 12 and the storage medium 13, respectively. The function of the normal voting machine 50 is to encrypt the accepted voting data and to send the encrypted voting data to the vote-recording machine 30 via a network 60. The normal voting machine 50 includes a voting/encryption unit 51 and an agent program 52, which correspond to the voting/encryption unit 21 and agent program 22, respectively. The normal voting machine 50 includes no storage medium. The network 60 may be a local area network (LAN), a virtual private network (VPN) on a public network, the Internet, or a network of another type. The agent programs 32, 42 and 52 communicate with each other via the network 60. The agent programs 32, 42 and 52 also designate time-out times related to communication when no response comes from the other agent program.

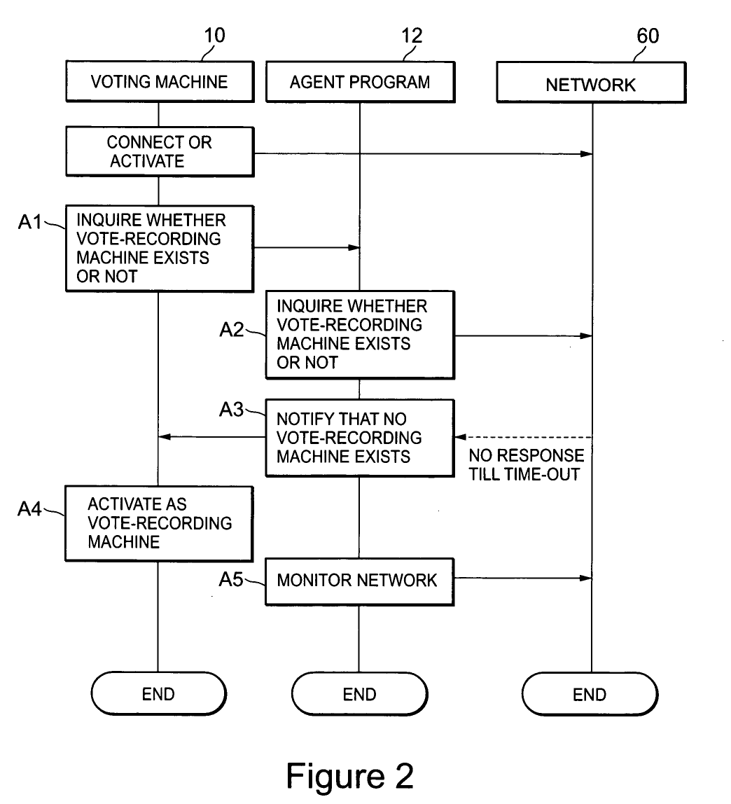

Operations of connecting the vote-recording machine 30, the backup voting machine 40 and the normal voting machine 50 to the network 60 will be described with reference to FIGS. 2, 3 and 4. These operations are conducted prior to executing a voting operation.

Referring to FIG. 2, the flow of processing when voting machine 10 including storage medium 13 functions as the vote-recording machine 30 will now be described.

Suppose that no vote-recording machine is initially connected to the network 60. When the voting machine 10 is connected to the network 60, the voting machine 10 inquires of the agent program 12 whether or not a vote-recording machine is connected to the network 60 (step A1). The agent program 12 inquires whether or not the recording a voting machine is connected to the network 60 by broadcasting to the network 60 (step A2) The agent program 12 waits for a response or a time-out. As no response is made, the agent program 12 notifies the voting machine 10 that no vote-recording machine is connected to the network 60 (Step A3) . After receiving that notification, the voting machine 10 activates itself as the vote-recording machine 30 (Step A4) The voting machine 10 is thus transformed into the vote-recording machine 30. The agent program 32 monitors the network 60 (Step A5).

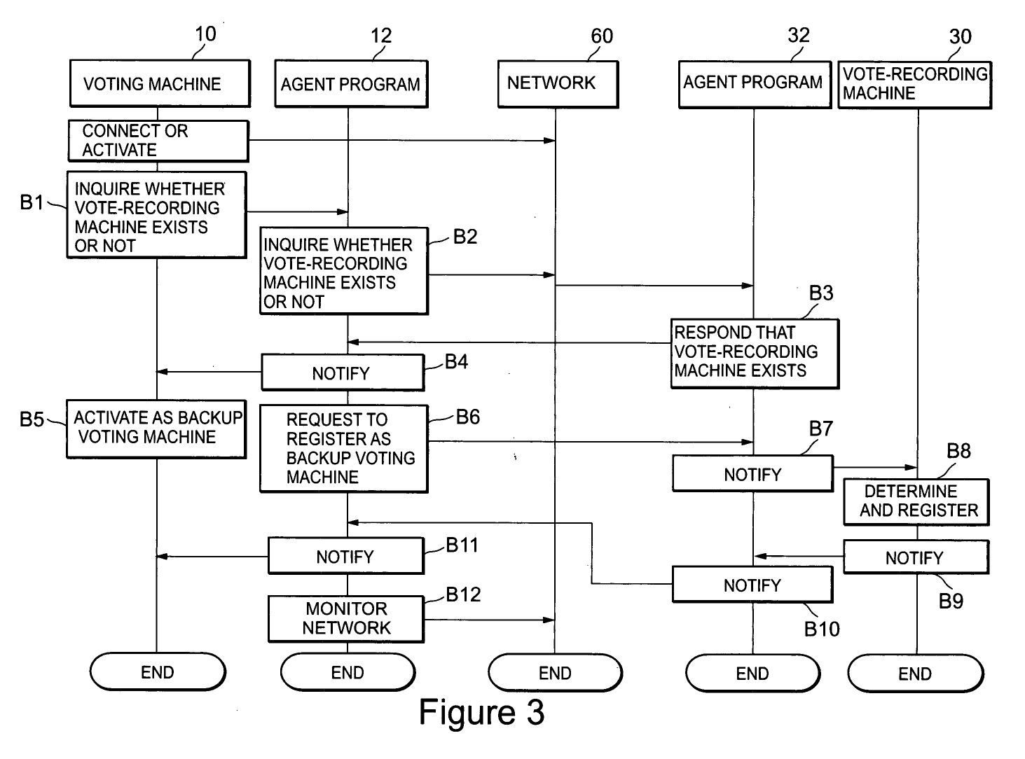

Referring to FIG. 3, the flow of processing when the voting machine 10 including a storage medium 13 functions as the backup voting machine 40 will now be described.

Suppose that the vote-recording machine 30 is connected to the network 60. When the voting machine 10 is connected to the network 60, the voting machine 10 inquires of the agent program 12 whether or not a vote-recording machine 30 is connected to the network 60 (Step B1). The agent program 12 inquires whether or not the vote-recording machine 30 is connected to the network 60 by broadcasting to the network 60 (Step B2) . The agent program 32 of the vote-recording machine 30, which is connected to the network 60, notifies the agent program 12 that a vote-recording machine 30 is connected to the network 60 (Step B3). The agent program 12 receives the notification from the agent program 32 and notifies the voting machine 10 that the vote-recording machine 30 is connected to the network 60 (Step B4). The voting machine 10 receives the notification and activates itself as a backup voting machine 40 (Step B5). The voting machine 10 is thus transformed into the backup voting machine 40. The agent program 42 requests the agent program 32 to register the backup voting machine 40 (Step B6). The agent program 32 notifies the vote-recording machine 30 that the agent program 32 is requested to register the backup voting machine 40 (Step B7). The vote-recording machine 30 receives the notification from the agent program 32 and determines the need of backup. When backup is required, the vote-recording machine 30 registers the backup voting machine 40 as a backup voting machine of the vote-recording machine 30. When the vote-recording machine 30 determines that backup is not required, the backup voting machine 40 is registered as the normal voting machine 50. The backup voting machine 40 is thus transformed into a normal voting machine 50. The need of backup shall be registered in the vote-recording machine 30 beforehand. The minimum number of backups required and the maximum number of allowable backups are registered in the vote-recording machine 30 and the need of backup is determined depending upon whether or not the number of backups is in the range. When the backup voting machine 40 is registered as a backup voting machine of the vote-recording machine 30, the vote-recording machine 30 notifies the agent program 32 that the backup voting machine 40 is used for a backup voting machine (Step B9). The agent program 32 notifies the agent program 42 that the backup voting machine 40 is registered as a backup voting machine of the vote-recording machine 30 (Step B10). The agent program 42 receives the notification from the agent program 32 and notifies that the backup voting machine 40 is registered in the vote-recording machine 30 as a backup voting machine of the vote-recording machine 30 (Step B11). The agent program 42 monitors the network 60 (Step B12)

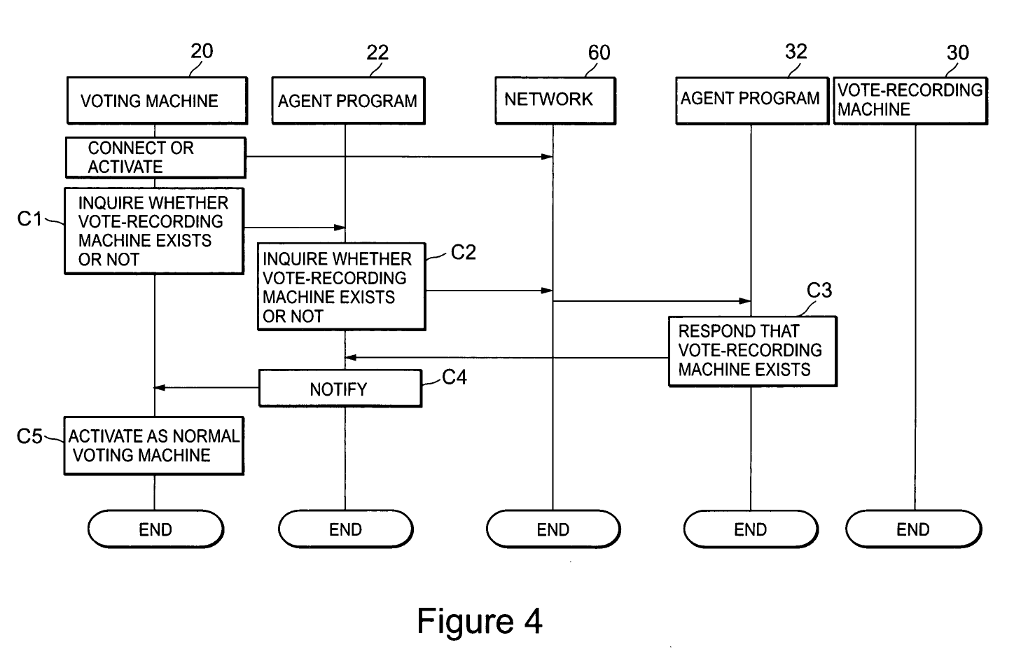

Referring to FIG. 4, the flow of processing when the voting machine 20 including no storage medium functions as the normal voting machine 50 will now be described.

Suppose that the vote-recording machine 30 and the backup voting machine 40 are connected to the network 60. When the voting machine 20 including no storage medium is connected to the network 60, the voting machine 20 inquires of the agent program 22 whether or not a vote-recording machine 30 is connected to the network 60 (Step C1). The agent program 22 inquires whether or not the vote-recording machine 30 is connected to the network 60 by broadcasting to the network 60 (Step C2). The agent program 32 of the vote-recordingmachine 30, which is connected to the network 60, notifies the agent program 22 that the vote-recording machine 30 is connected to the network 60 (Step C3). The agent program 22 receives the notification from the agent program 32 and notifies the voting machine 20 that the vote-recording machine 30 is connected to the network 60 (Step C4). The voting machine 20 receives the notification and activates itself as a normal voting machine 50 (Step C5). The voting machine 20 is transformed thus into a normal voting machine 50.

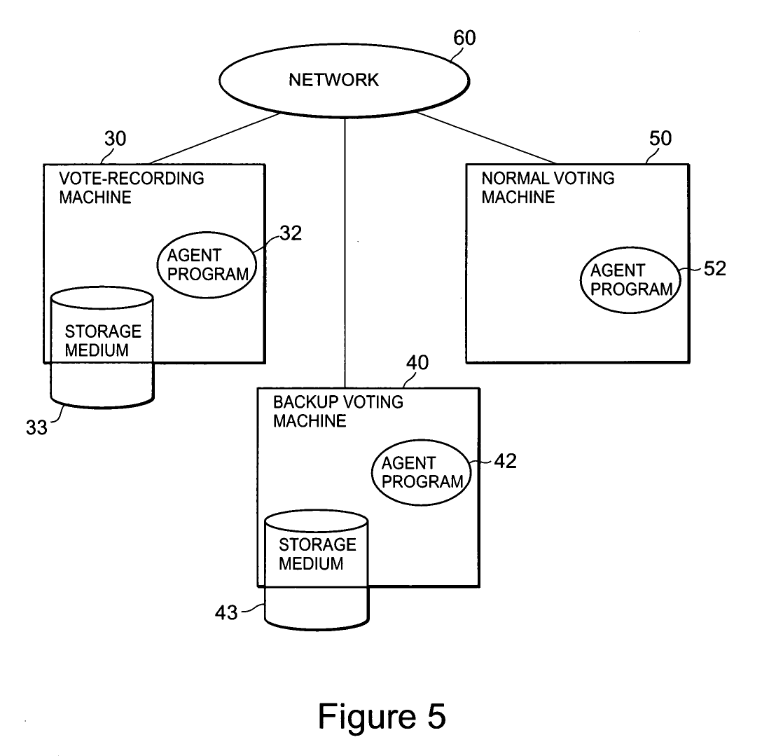

FIG. 5 shows a state in which the processing shown in FIGS. 2 to 4 has been executed and completed. This is a configuration in which preparation for voting is finished.

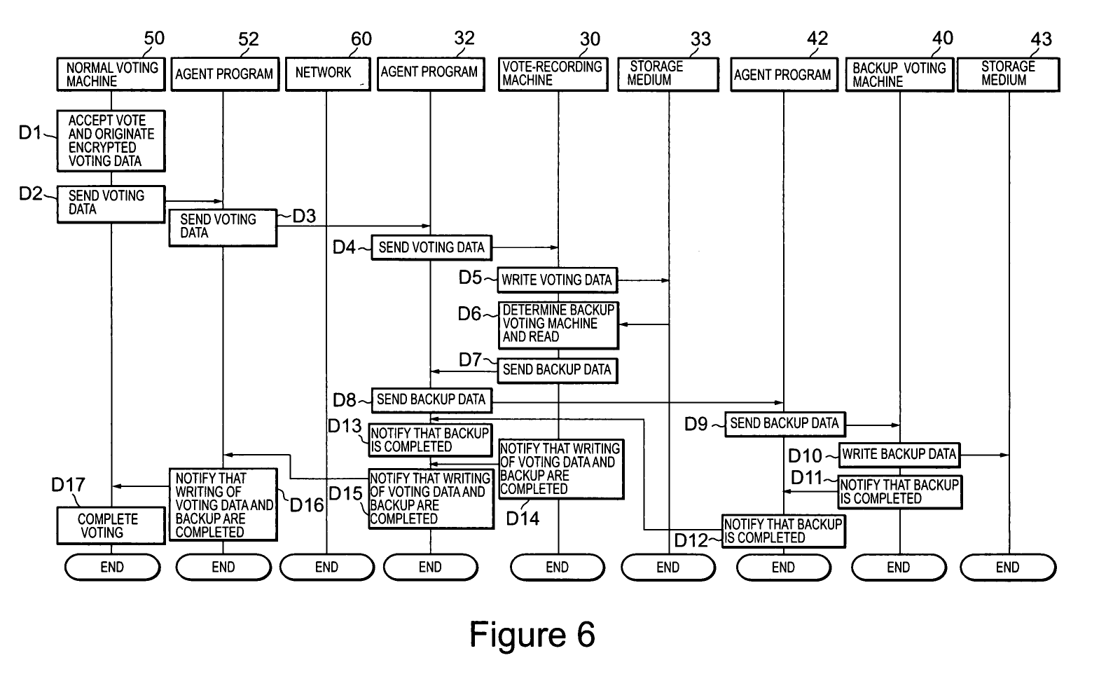

Referring to FIG. 6, the flow of processing when the encrypted voting data of the normal voting machine 50 is recorded will be described below. Suppose that the vote-recording machine 30, the backup voting machine 40 and the normal voting machine 50 are connected to the network 60.

The normal voting machine 50 accepts a vote and originates encrypted voting data (Step D1). The normal voting machine 50 sends the originated encrypted voting data to the agent program 52 (Step D2). The agent program 52 sends the received encrypted voting data to the agent program 32 in the vote-recording machine 30 via the network 60 (Step D3). The agent program 32 sends the encrypted voting data received from the agent program 52 to the vote-recording machine 30 (Step D4). The vote-recording machine 30 writes the received encrypted voting data to the storage medium 33 (Step D5). The vote-recording machine 30 reads the voting data written to the storage medium 33 when the backup voting machine 40 is connected to the network 60 (Step D6). The vote-recording machine 30 sends the voting data to be backed up to the agent program 32 after the vote-recording machine 30 reads the voting data (Step D7). The agent program 32 sends the voting data to be backed up to the agent program 42 in the backup voting machine 40 (Step D8). The agent program 42 receives the voting data to be backed up and sends the voting data to be backed up to the backup voting machine 40 (Step D9). The backup voting machine 40 writes the received voting data to be backed up to the storage medium 43 (Step D10). The backup voting machine 40 notifies the agent program 42 that writing to the storage medium 43 is completed (Step D11). The agent program 42 notifies the agent program 32 that backup is completed in the backup voting machine 40 (Step D12). The agent program 32 notifies the vote-recording machine 30 that the backup is completed (Step D13) The vote-recording machine 30 notifies the agent program 32 that the writing of the voting data is completed (Step D14). The agent program 32 notifies the agent program 52 that the writing and the backup are completed (Step D15). The agent program 52 notifies the normal voting machine 50 that the writing and the backup of the encrypted voting data are completed (Step D16). The normal voting machine 50 gets ready for the next voting after the normal voting machine 50 verifies that the writing and the backup of the data are completed (Step D17).

In the described embodiment, after all voting is finished, backup of all voting data may be performed in the backup voting machine 40. Namely, processing from a step D6 to a step D13 shown in FIG. 6 may be collectively executed after all voting is finished. Moreover, in the step D6, data to be backed up may be all data written to the storage medium 33.

In the described embodiment, when backup data is sent from the vote-recording machine 30 to the backup voting machine 40, reading from the storage medium 33 is not necessarily performed, and data sent from the normal voting machine 50 may be sent as it is. Namely, in a step D6 shown in FIG. 6, data to be backed up need not be read from the storage medium 33 and data sent from the normal voting machine 50 in a step D3 may be used.

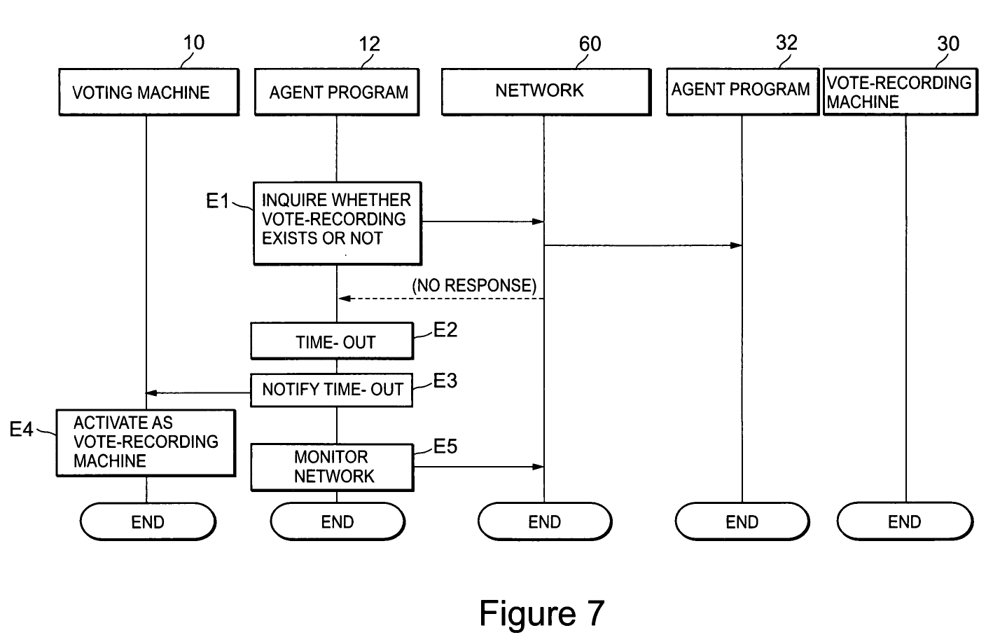

Referring to FIG. 7, the flow of processing when a spare vote-recording machine 30 is used, in case a fault occurs in the initial vote-recording machine 30, will now be described.

Suppose that the vote-recording machine 30 and the voting machine 10 are connected-to the network 60. Note that the voting machine 10 functions as a normal voting machine. Suppose that a fault occurs in the vote-recording machine 30 connected to the network 60. The agent program 12 periodically inquires whether or not the vote-recording machine 30 is connected to the network 60 by broadcasting to the network 60 (Step E1). An interval of the inquiry shall be registered in the agent program 12 beforehand. The agent program 12 detects a time-out since no response from the vote-recording machine 30 is received within time-out period determined in the agent program 12 (Step E2). Since a fault occurs in the vote-recording machine 30, there is no response from the vote-recording machine 30. The agent program 12 notifies the voting machine 10 that no response is made from the vote-recording machine 30 (Step E3). The voting machine 10 determines that a fault has occurred in the vote-recording machine 30 and activates itself as a vote-recording machine (Step E4). The agent program 12 monitors the network 60 (Step E5).

Embodiments of the present invention may have the following advantages:

The total number of storage media can be reduced by using storage media only in the vote-recording machine and the backup voting machine. This leads to advantages such as the reduction of reading time from the storage medium, the reduction of the cost for transport, the reduction of risk of damage and loss and the reduction of the cost for the storage media.

Since the agent program designates the function of the voting machine, setting up the vote-recording machine, the backup voting machine and the normal voting machine is automatically executed.

Although the invention has been described in connection with preferred embodiments thereof, it is to be understood that those embodiments are set forth solely to aid in understanding the invention, and should not be read in a sense to limit the scope of the invention. Modifications of the techniques described herein will be apparent to the skilled artisan when practicing the invention, and such modifications are to be construed as falling within the scope of the appended claims

What is claimed is:

1. A method of establishing a voting system, comprising of:
automatically allocating a vote-recording function to a first machine that includes a storage medium and that is first connected to a network;
automatically allocating a backup vote-recording function to a second machine that includes a storage medium and that is connected to the network; and
automatically allocating a normal voting function to at least one third machine that includes no storage medium and that is connected to the network.

2. The method as claimed in claim 1,
wherein each said machine includes an agent program, wherein said agent programs communicate with each other via the network and wherein each said machine is controlled by a said agent program.

3. The method as claimed in claim 1, further comprising:
automatically allocating a said vote-recording function to a said normal voting machine when a fault occurs in said vote-recording machine initially established.

4. The method as claimed in claim 3,
wherein said agent program in said normal voting machine monitors whether or not said fault occurs in said vote-recording machine.

5. A voting system comprising:
at least one normal voting machine which accepts a vote, generates encrypted voting data and outputs the encrypted voting data to a network;
at least one vote-recording machine which receives the encrypted voting data from the normal voting machine via the network, writes the encrypted voting data into a storage medium in the vote-recording machine and outputs the encrypted voting data to the network; and
at least one backup voting machine which receives the encrypted voting data from the vote-recording machine via the network, writes the encrypted voting data into a storage medium in the backup voting machine and outputs information that backup is completed in the backup voting machine to the network.

6. The voting system as claimed in claim 5,
wherein said vote-recording machine outputs all encrypted voting data to the network after all voting is finished.

7. The voting system as claimed in claim 5, further comprising a spare voting machine which functions as a spare voting recording machine when a failure occurs in said voting recording machine.

8. The voting system as claimed in claim 6, further comprising a spare voting machine which functions as a spare voting recording machine when a failure occurs in said voting recording machine.

9. The voting system as claimed in claim 5,
wherein said normal voting machine, said vote-recording machine and said backup voting machine include agent programs respectively, wherein said agent programs communicate with each other via the network and wherein said voting machine, said recording machine and said backup machine are controlled by the agent programs.

10. The voting system as claimed in claim 6,
wherein said normal voting machine, said vote-recording machine and said backup voting machine include agent programs respectively, wherein said agent programs communicate with each other via the network and wherein said voting machine, said recording machine and said backup machine are controlled by the agent programs.

11. A voting system comprising:
at least one normal voting machine which accepts a vote, generates encrypted voting data and outputs the encrypted voting data to a network;
a vote-recording machine which receives the encrypted voting data from the normal voting machine via the network and writes the encrypted voting data into a storage medium in the vote-recording machine; and
a backup voting machine which receives the encrypted voting data from the normal voting machine via the network, writes the encrypted voting data into a storage medium in the backup voting machine and outputs information that backup is completed in the backup voting machine to the network.

12. The voting system as claimed in claim 11, further comprising a spare voting machine which functions as a spare voting recording machine when a failure occurs in said voting recording machine.

13. The voting system as claimed in claim 11,
wherein said normal voting machine, said vote-recording machine and said backup voting machine include agent programs respectively, wherein each agent program communicates each other via the network and wherein said voting machine, said recording machine and said backup machine are controlled by the agent programs.
